(19) United States
(12) Patent Application Publication
(10) Pub. No.: US 2016/0306066 A1
(43) Pub. Date: Oct. 20, 2016

(54) ELECTROMAGNETIC SURVEYING AT LOW FREQUENCIES USING AN AIRBORNE TRANSMITTER WITH RECEIVERS ON THE GROUND

(71) Applicant: GEOTECH AIRBORNE LIMITED, St. Michael (BB)

(72) Inventors: Carlos IZARRA, Richmond Hill (CA); Andrei BAGRIANSKI, Toronto (CA); Alexander PRIKHODKO, Richmond Hill (CA); Pavel TISHIN, Richmond Hill (CA); Jack DODDS, Aurora (CA); Gene BOREL, Aurora (CA)

(73) Assignee: GEOTECH AIRBORNE LIMITED, St. Michael (BB)

(21) Appl. No.: 15/103,813

(22) PCT Filed: Dec. 11, 2014
(86) PCT No.: PCT/CA2014/051199

§ 371 Date: Jun. 10, 2016

Related U.S. Application Data
(60) Provisional application No. 61/915,284, filed on Dec. 12, 2013.
(60) Provisional application No. 61/994,351, filed on May 16, 2014.

(51) Int. Cl. G01V 3/165; G01V 3/38

(52) U.S. Cl. CPC G01V 3/165; G01V 3/38

(57) ABSTRACT

An airborne electromagnetic survey system in which a transmitter is airborne and receivers are located at a fixed position or positions on the ground.

This Application claims the benefit of and priority to (i) U.S. Patent Application No. 61/915,284, filed Dec. 12, 2013, the contents of which are incorporated herein by reference, and (ii) U.S. Patent Application No. 61/994,351, filed May 16, 2014, the contents of which are incorporated herein by reference.

### FIELD

This invention relates in general to the field of airborne geological mapping. This invention further relates to an apparatus for conducting geological surveying using an electromagnetic method.

### BACKGROUND

Electromagnetic (EM) survey techniques are widely used for geophysical surveying of the earth. There is a wide range of techniques. Some established techniques are “active source”, in which a signal is generated by the survey system; others are “natural source”, in which the signals are generated by natural phenomena such as distant thunderstorms. Techniques may be “frequency domain” (FD), in which the signal is analyzed as one or more sinusoidal components; or “time domain” (TD) in which the analysis measures the response of the earth when it is excited by an EM event of limited duration. Some survey systems are airborne, and acquire data while being transported over the survey area by an aircraft; some acquire data while being towed through the ocean; while others are ground based, using equipment that is moved from location to location on the surface of the earth, acquiring data while stationary.

An important advantage of airborne techniques is the speed with which large areas can be covered, which results in lower survey costs.

Airborne techniques have recognized disadvantages and challenges. An airborne system spends a relatively short time over each location in the survey area, which limits its ability to acquire low frequency (FD) or long delay time (TD) signals and to average multiple measurements to improve accuracy. It may be difficult to determine precisely the position of the equipment or to compensate for motion of the survey system. If receiver and transmitter are both mounted on or towed by the same aircraft, they are necessarily in close proximity, so that the transmitter's “primary” field is typically much stronger than the response of the earth. Vibration caused by the aircraft and by motion through the air causes noise in the electromagnetic receivers of the system. Galvanic coupling to the earth (i.e. connection through electrodes) is impractical for airborne equipment, making it difficult or impossible for it to measure low frequency electric fields.

The penetration of electromagnetic signals into the earth is limited by the electrical conductivity of the earth. For analysis in the frequency domain, the depth of penetration decreases roughly as the inverse square root of frequency, and as the inverse square root of conductivity, other things being equal. Similarly, in the time domain, depth of penetration increases as the delay time between excitation and detectable response increases, and decreases as conductivity increases.

Some highly conductive subsurface structures are difficult for some types of EM systems to detect because at higher frequencies their response to an exciting EM field is an undelayed replica of the exciting field waveform and indistinguishable from it. Such structures may be more easily detected using systems that provide measurements at low frequencies (FD) or long delay times (TD).

For the reasons identified in the previous two paragraphs, it is desirable in some applications to use an EM survey technique that acquires signals at low frequencies (FD) or long delay times (TD).

Airborne EM survey systems detect the magnetic component of EM signals. A directional magnetic sensor which vibrates or rotates in the static geomagnetic field senses a magnetic field fluctuation which is indistinguishable from an EM signal, and which is therefore noise superimposed on the desired signal. To reduce this effect, the EM receiver can be isolated to some extent from external sources of vibration, but that isolation becomes less effective as the frequency is reduced. As a result, airborne EM survey systems have had limited or no success at signal frequencies below 20 Hz (FD) or delay times of more than 12 ms (TD).

Consequently, airborne EM survey systems have had limited success in the detection of structures that require acquisition at low frequencies or long delay times due to their high conductivity, or to the conductivity and thickness of the overlying earth.

Some attempts have been made to address this problem by using a system in which an EM transmitter is placed in a fixed location on the ground, while the receiver is towed by an aircraft. The signal level generated by an EM transmitter depends both on the electrical power and current output of the transmitter electronics, and the area enclosed by the loop which accepts this output. The power available to an airborne transmitter and the size of the loop are both constrained by limitations on the size and weight that can be safely lifted and maneuvered by the aircraft. Placing the transmitter on the ground removes the weight constraint, and the loop can be replaced by a grounded dipole several kilometers in length. A disadvantage is that the airborne equipment must receive signals when the transmitter is kilometers distant, so that the received signals are weak. This configuration does not address the problem of noise caused by motion and vibration of the receiver, although attempts have been made to mitigate the noise by motion compensation techniques. Measurements of TD signals at delay times of 50 ms have been achieved in such systems. (See e.g. H. Ito et al. 2013. Grounded electrical-source airborne transient Electromagnetics (GREATEM) survey of Aso Volcano, Japan.)

The EM technique known as controlled source audio magnetotellurics (CSAMT) uses a fixed transmitter, typically driving a long grounded dipole, and a receiver moved from station to station on the surface of the earth. The transmitter-receiver separation is sufficient that the EM field at the receiver approximates a plane wave. A typical criterion is that the separation must be at least three skin depths. CSAMT surveys typically use a wide range of frequencies, and skin depth is frequency dependent, so this criterion is not precise. The receiver senses both electric and magnetic components of the EM field, and the ratios between those components are analyzed without reference to the transmitter position or the waveform that it generates other than its frequency. (J. J. Milsom and Asger Eriksen. 2011. Field Geophysics. 4th ed. Wiley ISBN: 978-1-119-95690-7.) CSAMT cannot be implemented with an airborne receiver because the data reduction uses measurements of the electric and magnetic fields at each survey station (information from the fixed transmitter is not used other than its frequency) which requires galvanic coupling with the earth.

### SUMMARY OF THE INVENTION

As discussed above, the performance of both the receiver and transmitter of an airborne EM survey system is limited by the physical size, motion, and vibration which are inherent in the airborne platform. Example embodiments described herein take advantage of the improvements of receiver and transmitter performance which are possible if the receiver is located in a fixed position on the ground while the transmitter is airborne.

### BRIEF DESCRIPTION OF THE DRAWINGS

FIG. 1 is a perspective diagrammatic view of an airborne electromagnetic survey system according to a first example embodiment.

FIG. 2 is a perspective diagrammatic view of an airborne electromagnetic survey system according to a second example embodiment.

FIG. 3 is a perspective diagrammatic view of an airborne electromagnetic survey system according to a third example embodiment.

FIG. 4 is a side elevation of an example embodiment of an airborne transmitter loop.

FIG. 5 is a front view of an airborne transmitter loop of FIG. 4.

### DETAILED DESCRIPTION OF EXAMPLE EMBODIMENTS

In at least some example embodiments, an EM survey system is provided that has a large airborne transmitter loop oriented in a vertical plane, so that its dipole moment vector is substantially horizontal when flown over a survey area or region. The system also includes a receiver system that includes two magnetic sensors located in a fixed position on the ground at the survey area or region. Since the receiver sensors are located far from the transmitters, it is unnecessary in at least some applications to buck out or otherwise compensate accurately for the transmitter primary field. This allows the transmitter loop to be designed to maximize transmitter dipole moment without compromises. A large, semi-rigid or flexible transmitter loop can be used as the airborne transmitter in at least some example embodiments. The system can be configured as a frequency domain (FD) system or as a time domain (TD) system which acquires data during both on- and off-times. In at least some examples, the use of ground based receiver sensors located apart from the transmitter loop can increase the received response in the case of targets which have strong in-phase (FD) or on time (TD) response. The performance of induction magnetic sensors depends strongly on size, and sensors located on the ground can be as large as necessary. The main limitation on airborne receiver sensitivity is noise caused by movement and vibration in the geomagnetic field, a limitation which can be minimized in ground based sensors, so the natural and man-made electromagnetic fields become the limiting noise sources for ground based sensors.

In at least some example embodiments, the transmitter loop is optimized to maximize coupling to the target. This is done by selecting a loop with a horizontal or vertical axis as appropriate. Alternatively, a loop having a dipole moment vector with horizontal and vertical components of the same order of magnitude can be flown in two or more directions over the survey area and the received responses combined to determine the response to a transmitter dipole having any orientation that is advantageous.

In at least some example embodiments, the fixed position of the receiver sensors on the ground is exploited to increase the amount and quality of the information derived from the received signals. In some embodiments, the receiver system may include magnetic sensors oriented in up to three independent directions and galvanically coupled electric sensors oriented in one or two independent directions. Some embodiments may include receiver systems at two or more locations on the ground which acquire data simultaneously.

In some example embodiments, a set of “remote” sensors may be positioned at a considerable distance (by way of non-limiting example, 10 km to 500 km) from the survey area, and may be used to sense the natural electromagnetic field. Since all the receiver locations are fixed, according to known theory, the horizontal magnetic components of natural (“magnetotelluric”) signals measured at the remote sensors are correlated by fixed transfer functions to the natural signals measured at all other sensor stations. The transfer functions can be determined and the magnetotelluric signals removed from the measurements at all other sensor stations. In at least some applications, this may provide a substantial improvement in the signal to noise ratio of the ground based sensors which could not be achieved in a moving airborne sensor.

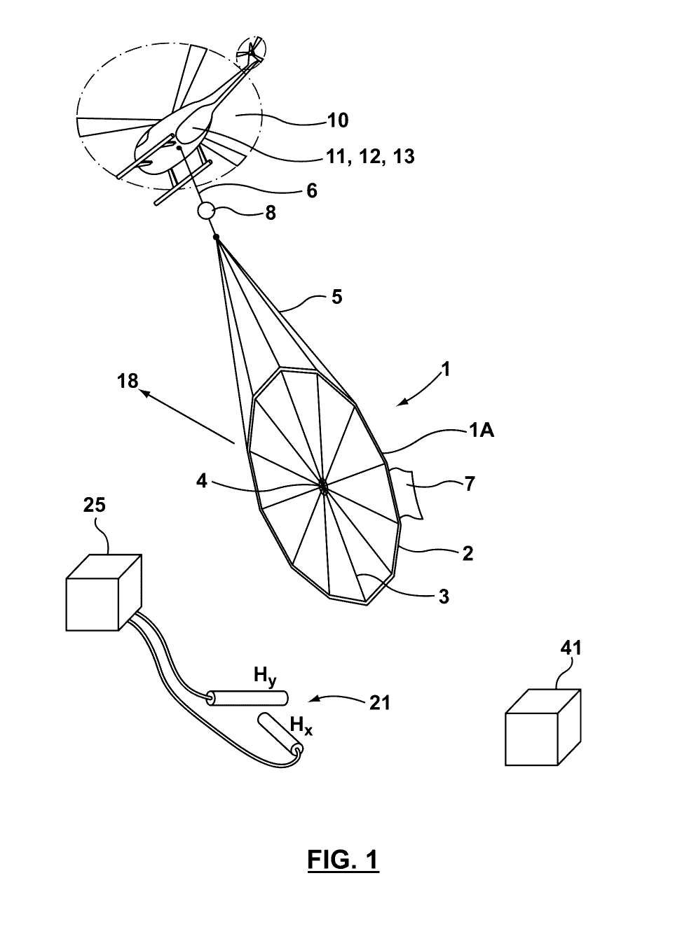

In a first example embodiment, referring to FIG. 1, an airborne EM geological surveying system includes an airborne transmitter loop 1 having a substantially horizontal axis perpendicular to the direction 18 of motion through the air; an airborne transmitter driver 11 which drives a controlled current waveform into the loop 1, with a low fundamental frequency (for example 1-5 Hz); an airborne sensor 8 attached to the transmitter loop and configured to monitor the loop current; a positioning monitoring system 12 (including, for example, one or more positioning sensors such as a flight path recovery camera and a GPS receiver); airborne data recording device 13 to record the measurements of the monitoring sensor and positioning package, synchronized to Universal Time; local ground based magnetic sensors 21, which in at least some example embodiments are configured to measure two orthogonal components of the horizontal field at a fixed location in the survey area; ground based data recording device 25 to record the measurements of the local sensors, synchronized to Universal Time; and a signal processing system 41 able to accept the signals recorded by the two data recording devices 13, 25 (either in real time using a telemetry system or after data collection is complete) and to process the signals recorded from the local ground based sensors 21 with reference to the signals recorded from the sensors of airborne monitoring systems 8, 12. In example embodiments the processing of the signals by data processing system 41 is performed according to known algorithms to obtain information on subsurface geological structures.

During use, the airborne components of the system are flown on parallel survey lines over a survey area using a helicopter 10, which houses the aforementioned transmitter 11, position monitoring system 12 and data recording device 13. The processing system 41, which may for example be implemented using an appropriately configured digital computer system, corrects the signals recorded at the local sensors 21 for fluctuations in the transmitted dipole moment determined in dependence on signals recorded by the loop current sensor 8. The processing system 41 computes transfer functions at one or more frequencies relating the transmitted dipole moment to the field measured by the local sensors 21 and maps parameters of the transfer functions based on the transmitter location as measured through position monitoring system 12. In addition, the transfer functions are input to geophysical inversion modelling software to determine parameters of subsurface structure that would account for the measured transfer functions.

In this first example embodiment, the transmitter loop 1 comprises one or more turns of electrical wire 1A supported by rigid tubular members 2 joined end to end to form a loop, which in the illustrated embodiment is a multi-sided simple polygon, but which could take other loop configurations such as circular. In an example embodiment, electrical wire 1A is supported internally within the tubular members 2 of the loop 1. The rigid members 2 lie substantially in a vertical plane oriented in the direction of flight such that the dipole axis of the loop is generally perpendicular to the flight direction 18 and horizontal to the ground. The rigid members 2 are maintained in position relative to each other by radial ropes 3 connected to a central point or hub 4, and by aerodynamic forces on the components of the loop 1 and on a drag device 7. The loop is supported by suspension ropes 5 which connect to a tow cable 6 at a common point. The tow cable 6 is connected to the towing aircraft 10 and supports the current measuring airborne sensor 8. The ends of the transmitter loop electrical wires 1A run up one of the suspension ropes 5, and the tow cable 6, through the current measuring airborne sensor 8, to the helicopter 10, and thence to the transmitter driver 11. Although the loop 1 shown in FIG. 1 has twelve sides (each comprising a tubular member 12), the loop 1 could have less than or more than 12 sides, and could be connected to aircraft 10 by more than or less than five suspension ropes 5.

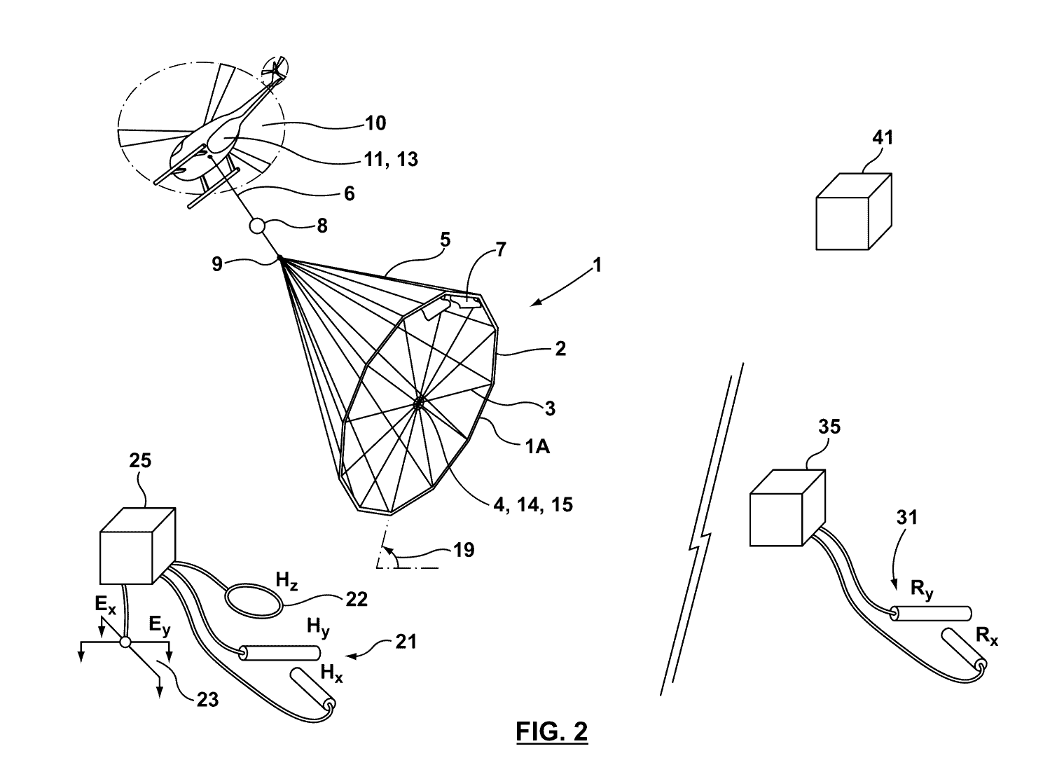

In a second example embodiment, referring to FIG. 2, an airborne EM geological surveying system includes: airborne transmitter loop 1 which is in the form of a regular polygon, lying in a plane which is oriented while in flight at an angle 19 (which may for example be 45° to 55° from the horizontal, but could be up to 90 degrees), the horizontal projection of the loop axis being substantially aligned with the direction of motion through the air; an airborne transmitter 11 which drives a controlled current waveform into the loop, with a low fundamental frequency (for example 1-5 Hz); a three axis magnetic sensor 14 in the center of the transmitter loop 1 and configured to monitor the transmitted magnetic field; a position and orientation monitoring device 15 attached to the monitoring sensor 14 and able to measure its position and orientation in geographical coordinates; data recording device 13 to record the measurements of the monitoring sensor, synchronized to Universal Time; local ground based electrical sensors 23, horizontal magnetic sensor 21, and vertical magnetic sensor 22 at a fixed location in the survey area; data recording device 25 to record the measurements of the local sensors 21, 22, and 23, synchronized to Universal Time; remote horizontal ground based magnetic sensors 31 at a location distant from the survey area; data recording device 35 to record the measurements of the remote sensors 31, synchronized to Universal Time; and a signal processing 41 system able to accept the signals recorded by the three data recording devices 13, 25, 31 and to process the signals recorded at the local sensors 21, 22, 23 with reference to the signals recorded from the monitoring sensors 14, 15 and remote sensors 31 according to known algorithms to obtain information on subsurface geological structures. The airborne components of the system are flown on survey lines over a survey area using a helicopter which houses the aforementioned transmitter 11 and data recording device 13. The processing system 41 uses measurements of the natural electromagnetic field (commonly known as “sferics” and “magnetotelluric signals”) as recorded at the remote sensors 31, to remove those components from the signal recorded at the local sensors 21, 22, 23, thereby enhancing the signal to noise ratio, using known algorithms. The processing system corrects the signals recorded at the local sensors for fluctuations in the transmitted dipole moment recorded by the monitor sensors 14, 15. Finally the processing system 41 computes transfer functions at one or more frequencies relating the transmitted dipole moment to the field at the local sensors.

In this second example embodiment, the transmitter loop 1 includes a transmitter coil 1A supported by a semi-rigid polygonal structure, configured to maintain the shape of the loop in the form of a regular polygon while in flight, while allowing deformation of the loop 1 during takeoff and landing so as to substantially reduce stress on the loop 1 compared to the stress that would be experienced by a rigid structure. (Examples of semi-rigid EM transmitter loops can be found in Canadian patent 2,450,155 and WIPO publication number WO2009/1055873A1. An example of a system used to monitor the dipole moment vector of a semi-rigid loop can be found in WIPO publication number WO2012/119254A1.) The polygonal structure of loop 1 consists of rigid tubular members 2 maintained at a fixed distance from a central hub 4 by radial ropes 3 connected to its vertices, and maintained substantially in a plane by suspension ropes 5 connected to a tow point 9, which is suspended from the aircraft 10 by a suspension rope 6. Drag-producing elements 7 cause the loop to take up the desired orientation during flight.

Depending on characteristics of the geology and the intended target of the survey system, various survey configurations of this second example embodiment may be used. In the simplest survey design, the system may be flown on a set of parallel survey lines. If subsurface features are aligned with a known “strike” direction, the system may be flown in both directions along survey lines substantially perpendicular to the strike; information on the orientation recorded by the monitoring sensors during the two passes along the survey lines may be processed to resolve the response to vertical, and along-line horizontal transmitted magnetic dipole fields. In more complex geology, two or more sets of survey lines may be flown and the results processed to resolve the response to vertical, and two orthogonal horizontal transmitted dipole fields.

In some example embodiments, the loop 1 of the system of FIG. 2 is flown with its dipole axis in substantially a vertical orientation, such that angle 19 is approximately 0 degrees. In such a configuration, the TDEM system shown in Canadian patent 2,450,155 and WIPO publication number WO2009/1055873A1 can be used to provide the transmitter loop functionality. In some example embodiments, the ground based equipment shown in FIG. 2 is used in combination with a TDEM system such as shown in Canadian patent 2,450,155 and WIPO publication number WO2009/1055873A1. In such a configuration, the airborne compents can include all the functionality of the TDEM system shown in Canadian patent 2,450,155 and WIPO publication number WO2009/1055873A1, and airborne monitor sensors 14,15 can include a concentric receiver coil for measuring the secondary response to primary signals generated by transmitter loop 1. In such a configuration, the airborne receiver coil can provide one data set representing the resulting magnetic components of secondary EM signals generated in response to transmitter loop transmissions, and the ground based sensors can provide a second representative data set. Both data sets can then be interpreted to provide complimentary information on subsurface geological structures.

In some example embodiments, the loop 1 of FIG. 1, with the dipole axis horizontal and perpendicular to the direction of travel, is used with the ground based components of FIG. 2, namely the three component B-field sensors 21, 22 and the E-field sensors 23. The use of E-field sensors can in some applications permit magnetotelluric (MT) transfer functions to be computed when the transmitter loop 1 is not present.

In the systems described herein, parameters calculated from the transmitted and received signals may in some example embodiments be chosen to enhance the signal of interest from the earth response that is being computed and to attenuate some effects cause by movement, rotation, and changes in shape of the transmitter loop 1, as well as timing differences between the two data recording devices 13 and 25. Examples of such parameters are the ratios between the amplitude of a harmonic component of the received signal (especially an odd harmonic) and the amplitude of the fundamental component; the ratio between the phase of a harmonic relative to the phase of the fundamental (i.e. Pn-nP1); the ratio between the amplitudes of the fundamental components at two receivers located at different locations on the ground; and the amplitude of the fundamental component resolved from the two horizontal receiver signals along the direction from transmitter to receiver. Such parameters may attenuate the effects of rotation of the dipole axis of the transmitter loop; and variations of the dipole moment of the transmitter caused by flexing of the sides of the transmitter loop 1, for example.

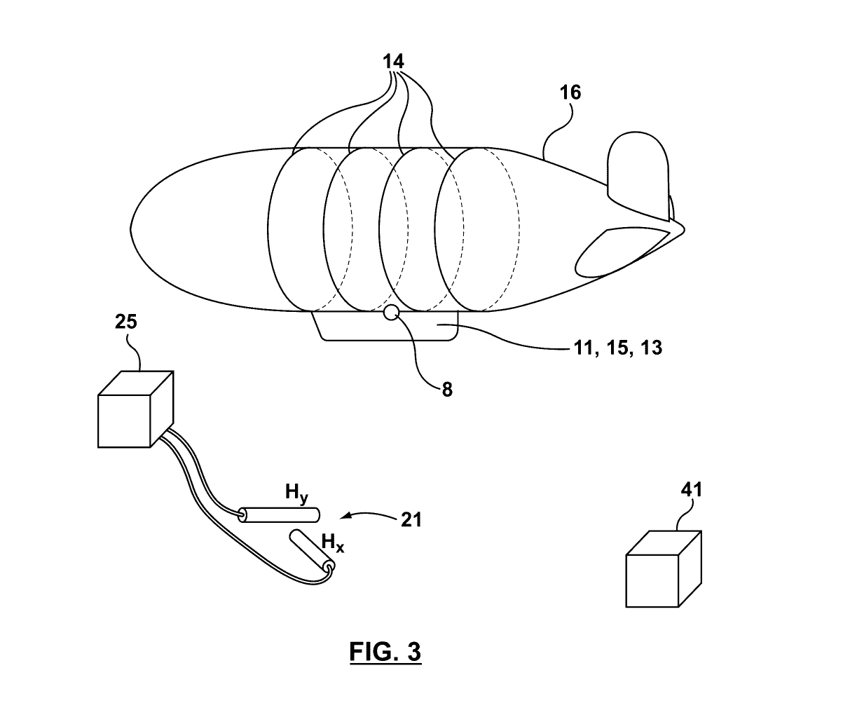

In a third example embodiment, referring to FIG. 3, a multiple turn transmitter loop 14 is integrated with the envelope of an airship 16 to generate a large dipole moment oriented substantially horizontal and parallel to the longitudinal axis of the airship. The transmitter loop current is measured by a current sensor 8 placed in the loop. The airship gondola houses the transmitter 11, a position and orientation package 15 able to measure the position and orientation of the airship (and therefore the loop) in geographical coordinates; means 13 to record the measurements of the position and orientation monitoring package and the current sensor, synchronized to Universal Time. Other components of the system are as described in the first two example embodiments. It will be appreciated that almost any desired loop orientation could be achieved using the same airship envelope.

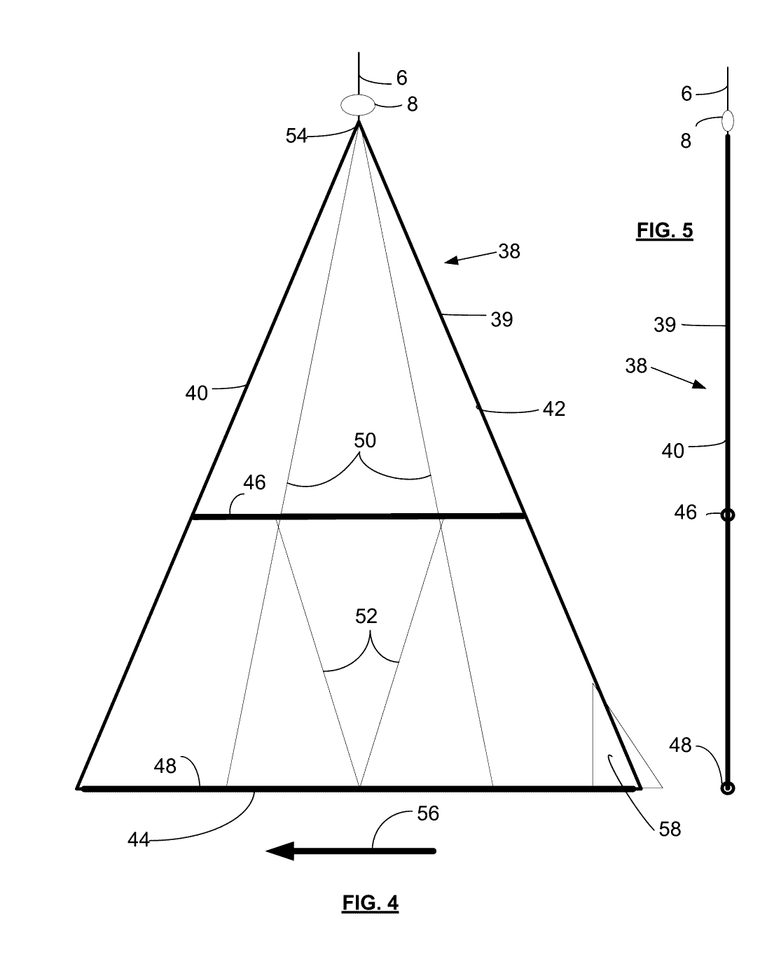

FIGS. 4 and 5 illustrate side and front views, respectively, of a further example of an airborne transmitter loop assembly 38 that can be suspended from aircraft 10 by tow cable 6 in place of the transmitter loop 1 for the airborne EM geological surveying system described above in respect of FIG. 1. Airborne transmitter loop assembly 38, which functions electrically in a manner similar to loop 1 described above, has a triangular profile in flight, with a substantially horizontal axis perpendicular to the direction 56 of motion through the air.

The transmitter loop assembly 38 includes a transmitter coil 39 that comprises one or more turns of electrical wire that is supported, when in flight, in the form of a triangle that extends in a vertical plane that is parallel to the direction of travel 56 such that the dipole axis of the transmitter coil is substantially perpendicular to the direction of flight and parallel to the ground. In this regard, the transmitter coil 39 forms first, second and third sides 40, 42 and 44 of a triangular structure, which in at least some embodiments can be a substantially isosceles triangle. First and second sides 40 and 42 (which are leading and trailing sides, respectively when in flight) are joined at their upper ends at apex 54, with their spaced-apart lower ends each being joined at a respective end of the third side 44 (which in at least some embodiments is substantially horizontal when in flight).

In an example embodiment, the transmitter loop assembly 38 includes first and second support members 46 and 48 to help maintain the triangular shape of the transmitter coil 39 during flight. In one example embodiment first and second support members 46 and 48 are tubular and formed from non-conducting rigid composite material. The first support member 46 extends between first and second sides 40 and 42 at an intermediate location between apex 54 and third side 44. In some embodiments one end of the first support member 46 engages the transmitter coil 39 at its first side 40 at a location that is close to or just below the mid-point of first side 40, and the other end of the first support member 46 engages the transmitter coil 39 at its second side 42 at a location that is close to or just below the mid-point of second side 42.

In an example embodiment, the portion of the transmitter coil 39 that forms the third side 44 is received within and extends through the the tubular second support member 48, such that the second support member 48 rigidly defines the third side of 44 of the triangular structure. In example embodiments, the support members 46 and 48 are substantially parallel to each other and are maintained in a generally horizontal position during flight. Although only two support members 46 and 48 are shown in the figures, the transmitter loop assembly 38 could include additional support members extending between first and second sides 40 and 42.

In example embodiments, ropes 50 and 52 are used to provide additional support to the transmitter loop assembly 38 and maintain the relative locations of support members 46, 48 and apex 54 during flight. In the illustrated embodiment, ropes 50 extend from apex 54 in an inverted “V” configuration to secure and support spaced apart locations of both the first support member 46 and the second support member 48. Ropes 52 extend in an generally upright “V” shape from second support member 48 to first support member 46. Additional ropes, or ropes in different configurations, can also be provided to maintain the relative locations of support members 46 and 48 (and thus the shape of the triangular coil 39) during flight. In an example embodiment the transmitter loop assembly 38 may include a drag device 58 to assist in maintain the orientation of the loop assembly during flight.

In example embodiments, the electrical wire forming the one or more loops of transmitter coil 39 is a multi-strand wire covered with an insulating layer, such that the transmitter coil 39 is generally flexible and bendable about its perimeter except where its shape is maintained by support members 46 and 48 and ropes 50, 52. This configuration allows the first and second sides 40 and 42 of the transmitter loop assembly 38 to substantially fold up or collapse when in contact with the ground, allowing for takeoff and landing of the towing aircraft. Thus, the transmitter loop assembly 38 takes on the triangular form shown in FIG. 4 only once it is airborne, after which the sides 40, 42 and 44 are maintained in a triangular position by a combination of support members 46, 48, ropes 50 and 52 and gravitational and aerodynamic forces on the components of the loop assembly 38.

The loop assembly 38 is connected at apex 54 to tow cable 6. As described earlier in respect of FIG. 1, the tow cable 6 is connected to the towing aircraft 10 and supports the current measuring airborne sensor 8. The ends of the transmitter loop electrical wires run up tow cable 6, through the current measuring airborne sensor 8, to the helicopter 10, and thence to the transmitter driver 11.

Although the loop assembly can take a number of different sizes, in one non-limiting example, the first and second sides 40, 42 are approximately 60 meters in length, and the third side 44 is approximately 40 meters in length. Many different sizes and configurations can be used to create a collapsible loop assembly 38, and the transmitter coil can be configured to take a other simple polygonal flight shapes other than that of a triangle in some embodiments.

It will be appreciated that the many embodiments of the invention are possible, including those that combine features of more than one of the example embodiments, which are presented as examples only.

1. An airborne electromagnetic (AEM) geophysical surveying system comprising:
(a) airborne components for attachment to an aircraft which is flown over a survey area, including:
a transmitter loop;
a transmitter driver which drives a controlled current waveform into the loop;
a monitoring system generating measurements; and;
(b) ground based components located at a fixed position or positions on the ground:
one or more magnetic or electrical field sensors;
and a signal processing system able to accept the signals from the monitoring system and the magnetic or electrical field sensors and process the signals to obtain information on subsurface geological structures.

2. The system of claim 1 wherein the monitoring system includes a sensor for determining geographical position.

3. The system of claim 2 wherein the monitoring system includes a sensor which measures the current in the transmitter loop.

4. The system of claim 1 wherein the transmitter loop is in a form approximating a circle, and the monitoring system includes a magnetic sensor located at a center of the transmitter loop which is able to measure the magnetic field generated by the transmitter loop.

5. (canceled)

6. The system of claim 4 wherein the magnetic sensor of the monitoring system measures three independent vector components of the transmitter magnetic field and the monitoring system includes an orientation sensor that measures orientation of the magnetic sensor of the monitoring system.

7. The system of claim 1 wherein the processing system mitigates noise originating in the natural electromagnetic field by combining signals from ground sensors located at two or more different locations.

8. The system of claim 7 wherein the ground based components include two magnetic sensors in different horizontal orientations and located far enough from the survey area so that the signals originating in the natural electromagnetic field are usually stronger than the signals received from the airborne transmitter.

9. The system of claim 1 where the transmitter loop lies substantially in a vertical plane which is aligned with the direction of flight.

10. The system of claim 1 where the transmitter loop lies in a horizontal plane.

11. The system of claim 1 where the transmitter loop lies in a plane which is tilted so that the magnetic field that is generated includes a vertical component and a horizontal component that is substantially aligned with the direction of flight.

12. The system of claim 9 where the transmitter loop has a semi-rigid support frame that has rigid tubular sections and flexible ropes configured so as to substantially reduce the stress during takeoff and landing, while maintaining a rigid geometry while in flight.

13. (canceled)

14. (canceled)

15. (canceled)

16. The system of claim 1 wherein the controlled current waveform the transmitter driver drives into the loop has a fundamental frequency of 1 to 5 Hz.

17. The system of claim 1 wherein the airborne components includes a receiver coil for measuring a magnetic component of EM signals generated in the survey area in response to signals transmitted by the transmitter loop.

18. The system of claim 1 wherein the transmitter loop is collapsible on takeoff and landing and comprises a transmitter coil that includes spaced apart rigid support members to maintain the transmitter coil in a predetermined shape during flight.

19. A method for conducting airborne electromagnetic surveying comprising:
positioning ground based components on a ground surface at a survey area, the ground based components comprising one or more magnetic or electrical field sensors;
flying airborne components over the survey area, the airborne components comprising: a transmitter loop, a transmitter driver which drives a controlled current waveform into the loop, and a monitoring system for monitoring one or more characteristics of the transmitter loop;
receiving ground based measurement signals from the one or more magnetic or electrical field sensors generated in response to signals transmitted by the transmitter loop;
receiving signals from the monitoring system; and
processing the ground based measurement signals and the signals from the monitoring system to obtain information on subsurface geological structures within the survey area.

20. The method claim 19 wherein the monitoring system includes a sensor for determining geographical position and a current sensor which measures the current in the transmitter loop

21. The method of claim 19 wherein the monitoring system includes a magnetic sensor located at a center of the transmitter loop which is able to measure the magnetic field generated by the transmitter loop.

22. The method of claim 21 wherein the magnetic sensor of the monitoring system measures three independent vector components of the transmitter magnetic field and the monitoring system includes an orientation sensor that measures orientation of the magnetic sensor of the monitoring system.

23. The method of claim 19 comprising positioning further ground based magnetic sensors remote from the survey area, and processing the ground based measurement signals and the signals from the monitoring system comprises combining signals from the one or more magnetic or electrical field sensors and the further ground based magnetic sensors to mitigate noise originating in a the natural electromagnetic field.

24. The method of claim 19 wherein during flying the transmitter loop lies substantially in a vertical plane which is aligned with the direction of flight.

25. The method of claim 19 wherein during flying the transmitter loop lies in a horizontal plane.

26. The method of claim 19 wherein during flying the transmitter loop lies in a plane which is tilted so that the magnetic field that is generated includes a vertical component and a horizontal component that is substantially aligned with the direction of flight.

27. The method of claim 19 wherein the controlled current waveform the transmitter driver drives into the transmitter loop has a fundamental frequency of 1 to 5 Hz.

28. The method of claim 19 wherein the airborne components include a receiver coil for measuring a magnetic component of EM signals generated in the survey area in response to signals transmitted by the transmitter loop, and wherein processing comprises processing the magnetic component to obtain further information on subsurface geological structures within the survey area.
